(19) United States
(12) Patent Application Publication
(10) Pub. No.: US 2020/0003523 A1
(43) Pub. Date: Jan. 2, 2020

(54) APPARATUS AND METHOD FOR ASSISTING WITH FIREARM AIMING

(71) Applicant: AxCM Solutions, LLC, Rochester, NY (US)

(72) Inventors: Michael C. Lacagnina, Penfield, NY (US); Curt W. Drewel, Greece, NY (US)

(73) Assignee: AxCM Solutions, LLC, Rochester, NY (US)

(21) Appl. No.: 16/251,152

(22) Filed: Jan. 18, 2019

Related U.S. Application Data
(60) Provisional application No. 62/618,760, filed on Jan. 18, 2018.

(51) Int. Cl. F41G 3/08; G02B 27/01

(52) U.S. Cl. CPC F41G 3/08; G02B 2027/0178; G02B 27/0176; G02B 27/0172

(57) ABSTRACT

An apparatus for assisting an operator in aiming a firearm with a sighting scope includes a hands-free communications device including both an input device for generating an audio input and an output device for receiving a set of information; a ballistics processing unit for receiving a machine-readable input and generating machine readable output corresponding with the set of information usable by the operator for aiming the firearm with the sighting scope; and an audio/visual interface, communicatively coupling the hands-free communication device and the ballistics processing unit for converting the audio based input generated with the hands-free communications device into the machine readable input, converting the machine readable output generated with the ballistics processing unit into the set of information usable by the operator for aiming the firearm with the sighting scope, and communicating the set of information usable by the operator for aiming the firearm with the sighting scope from the audio/visual interface to the hands-free communications device.

### PRIORITY INFORMATION

The present application claims priority, under 35 U.S.C. § 119(e), from U.S. Provisional Patent Application No. 62/618,760, filed on Jan. 18, 2018. The entire content of U.S. Provisional Patent Application No. 62/618,760, filed on Jan. 18, 2018, is hereby incorporated by reference.

### BACKGROUND

Accuracy in shooting a firearm at relatively short distance, e.g., 100 yards or less, can be quite high, provided the operator employs a reasonable amount of skill while using a suitable firearm and bullets. That is, at relatively short distances, when the firearm is properly zeroed and the ammunition is maintained within desired limits, a firearm can be operated with little concern as to environmental conditions, such as wind and range.

On the other hand, at longer ranges, in excess of 500 yards, for instance, various factors affect the flight of a bullet and, if long range targets are going to be hit precisely, then factors and conditions such as target distance, crosswind strength, humidity, barometric pressure, Coriolis effect, and temperature, among others, must be considered and compensated for. Accordingly, when shooting over longer ranges, it is important for the operator to make certain accommodations in sighting or aiming so as to take environmental conditions into account.

As recognized in the prior art, “bullet drop” has a critical impact on bullet flight. That is, gravity causes a bullet to drop in elevation as the bullet travels from the firearm to the target. If a hunter 100 (FIG. 1) is close to his target 102, the bullet drops very little, represented by the adjusted trajectory 104. Improvements in firearms and ammunition have, however, allowed hunters to target game from long distances. At these greater distances, gravity causes a bullet to drop in elevation more significantly, as represented by the adjusted trajectory 106 in FIG. 2.

Referring to FIG. 3 and FIG. 4, sighting scopes, such as riflescopes, generally provide a magnified field of view 200 of the target 208. By placing an intended target 208 within the field of view 200 and aiming the rifle with the crosshairs 204 and 206, the riflescope improves the aiming accuracy for a rifleman for shots taken over long distances. Many riflescopes provide a reticle, which is an aiming device superimposed on the field of view 200 and consists of a vertical crosshair 204 and a horizontal crosshair 206. An operator can use the intersection 210 of the vertical 204 and horizontal 206 crosshairs to aim the rifle. By “holding over” the target, i.e., holding the intersection 210 over the target 208, at longer distances, the operator can deliver the bullet to the aiming point represented by the intersection 210. Further teaching regarding the use of crosshairs or indexed reticles may be obtained by reference to U.S. Pat. No. 6,729,062, the entire disclosure of which is incorporated herein by reference.

As also recognized in the prior art, wind can dramatically alter a bullet's point of impact. In compensating for wind, an expert operator might use his or her knowledge and past experience to “estimate” the expected wind-induced leftward or rightward deflection of a bullet to be fired and make the corresponding aiming point compensation by shifting the scope's crosshairs either left or right of the desired impact point. Such an adjustment is commonly is referred to as “holding off” for the wind or “windage hold-off.” When shooting long distances, particularly when encountering significant crosswind, hold-off can amount to several feet of horizontal aiming point compensation. One of the keys to effective windage hold-off is in accurately reading the downrange wind speeds, and then in understanding how those values of wind speed will affect the bullet's flight.

Various approaches have been proposed for improving long distance sighting of a firearm. In one approach, operators are provided with a riflescope having aiming points (or hash marks) in addition to the central aiming point formed by a center horizontal hairline and a center vertical hairline that forms an aiming point at the center of a reticle. These conventional reticles, known as bullet drop compensation reticles, typically have a plurality of aiming points formed by a plurality of intersecting hairlines located at predetermined distances below the central aiming point. Bullet drop compensation reticles may provide additional horizontal hairlines at specified distances below the center horizontal hairline so as to form the additional aiming points where those additional horizontal hairlines intersect the center vertical hairline. See e.g., U.S. Pat. Nos. 5,920,995 and 6,591,537, the entire disclosures of which are hereby incorporated herein by reference.

In another approach, a telescopic sight for automatically compensating for bullet trajectory deviation is disclosed in U.S. Patent Application Publication No. 2007/0277421, the entire disclosure of which is incorporated herein by reference. The sight includes a user input and an electronic port for communicating ballistic, calibration and user preference information to the sight. The sight further includes a ranger finder and an array of ambient condition sensors for automatically generating target distance information and ambient condition information. A processor uses the ballistic, calibration, user preference, distance, and ambient condition information to calculate bullet trajectory deviation compensation information. The processor presents the compensation to the user in the form of a compensation reticle or a compensation value.

The prior art includes several other approaches employing high end riflescopes in sighting systems. For example, U.S. Pat. No. 7,703,679, the entire disclosure of which is incorporated herein by reference, discloses a sighting system for visually acquiring a target, the sighting system including an optic device having a transmissive LCD array affixed thereon. The transmissive LCD array includes two or more LCD elements that are separately addressable to provide an aiming point. In embodiments, the sighting system receives information from an input system, such as ammunition information or environmental information, executes a ballistics program to determine ballistics information using the received information, and determines a range to the target. A controller calculates an aiming point using the ballistics information and the target range. The controller then addresses or energizes one of the LCD elements to provide the aiming point.

In another example, U.S. Patent Application Publication No. 2015/0153139, the entire disclosure of which is incorporated herein by reference, discloses a scope that may include an adjustment dial, which may be moved among a plurality of positions to configure the scope to compensate for projectile drops. The adjustment dial may be labeled with dial-calibration data, which may include one or more distance indicators and/or one or more windage hold-off indicators. The scope may be attached to a gun and the dial-calibration data may be at least partially generated using ballistics performance data based on shots fired by the gun. The dial-calibration data may be at least partially generated using shooting conditions. An electronic device may include a derived distance calculation module, which may be configured to use a distance to a target and actual shooting conditions to calculate a derived firing solution. The derived distance may be used in connection with an adjustment dial labeled with dial-calibration data at least partially generated using shooting conditions different from the actual shooting conditions.

While numerous prior art firearm sighting systems are well suited for their intended purpose, many of the more effective prior art sighting systems can be costly. For example, one prior implementation automatically accommodates for bullet trajectory deviation while automatically generating a graphic sighting pattern. It follows, however, that this level of automated sighting functionality comes with a considerable price tag. On the other hand, operation of several less costly prior art sighting systems can be time consuming—losing time during sighting can be particularly counterproductive when the allotted time for sighting (as in shooting competitions) is significantly constrained. Once an operator has positioned his firearm, it can be quite undesirable to move off the firearm for interaction with related paraphernalia such as a handheld ballistics calculator, pencil and paper, data sheets and/or ambient condition sensors. There is a need for a relatively inexpensive, flexible firearm sighting system that possesses a certain degree of automation and does not require the operator to move off his gun once it is suitably positioned.

### BRIEF DESCRIPTION OF THE DRAWINGS

FIG. 1 and FIG. 2 are schematic, simplified representations of the effect of gravity on the flight of a bullet.

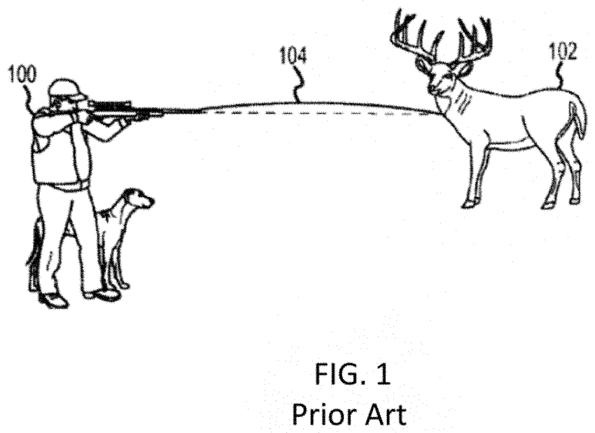

FIG. 3 and FIG. 4 are schematic, simplified representations of the field of view from a rifle scope and different aiming situations often encountered by a firearm operator.

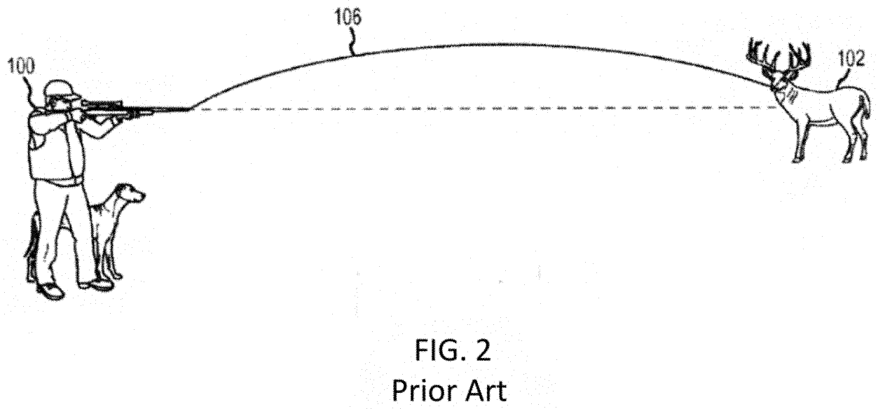

FIG. 5 is a schematic diagram of an exemplary embodiment of a system operable for assisting an operator in aiming a firearm.

FIG. 6 is a block diagram of a ballistics processing unit (“ballistics processing unit”) operable with the firearm aiming assistance system of FIG. 5.

FIG. 7 is a schematic, block diagram of an exemplary user communication model operable with the firearm aiming assistance system of FIG. 5.

FIG. 8 is a flow diagram representing one example of a signal processing implementation usable with the communication model of FIG. 7.

FIG. 9 is a schematic block diagram of an exemplary architecture operable with the ballistics processing unit of FIG. 6.

FIG. 10 is a flow diagram illustrating an exemplary routine for obtaining a firing solution with the firearm aiming assistance system of FIG. 5.

FIG. 11 is a schematic representation illustrating some objects obtainable with the exemplary implementation of FIG. 10.

FIG. 12 is a flow diagram illustrating an exemplary implementation for establishing a verbally recognizable object in a rifle library.

FIG. 13 is a flow diagram illustrating an exemplary implementation for establishing a verbally recognizable object in an ammunition library.

FIG. 14 is a flow diagram illustrating an exemplary implementation for dynamic factors and conditions input subroutine of the exemplary routine of FIG. 10.

FIG. 15 is a flow diagram of an exemplary implementation of a main control loop for processing verbal commands with the ballistics processing unit.

FIG. 16 is a flow diagram illustrating an exemplary approach for using a verbal command to store a target package.

FIG. 17 is a flow diagram illustrating an exemplary approach for using a verbal command to recall a set of values for a target package.

FIG. 18 is a perspective view of a pair of smart glasses, including input/output device(s), the smart glasses being usable with the firearm aiming assistance system of FIG. 5.

FIG. 19 is a schematic representation illustrating an exemplary manner in which the pair of smart glasses of FIG. 18 can be used to overlay an image corresponding with a given firing solution on a conventional firearm scope.

### DETAILED DESCRIPTION

For a general understanding, reference is made to the drawings. In the drawings, in some instances, like references have been used throughout to designate identical or equivalent elements. It is also noted that the drawings may not have been drawn to scale and that certain regions may have been purposely drawn disproportionately so that the features and concepts may be properly illustrated.

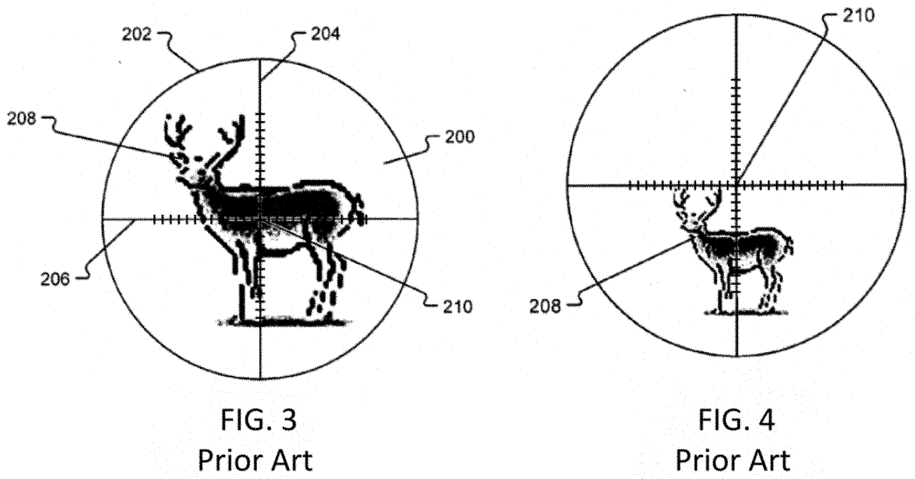

Referring to FIG. 5, a system for assisting an operator in aiming a firearm (or other associated ballistics implement) is designated with the numeral 300. The system 300 includes a hands-free headset 302 communicatively coupled with a ballistics processing unit 304 by way of wired or wireless connection 306. In practice, the headset is worn by an operator and, in one example, includes a microphone (microphone not visible in FIG. 5) for providing audio input from the headset (i.e., from the operator) to the ballistics processing unit 304. Additionally, the headset includes speakers 308 so that audio output can be provided to an operator when wearing the headset. As will be described below, optional imaginal output can be provided to the operator, either separately from, or in conjunction with the audio output.

The connection 306 may be implemented with a low power wireless communication system, such as Bluetooth™ or any other suitable communication system. Also, as will be appreciated by those skilled in the art, the system 300 can be advantageously used in conjunction with sensors 314, the sensors 314 being used to measure ambient environmental conditions. Finally, a user interface, which may include any suitable tactile input devices designated with the numeral 315. In one example, administrative commands, the significance of which will appear below, may be communicated to the ballistics processing unit 304 by way of the UI 315.

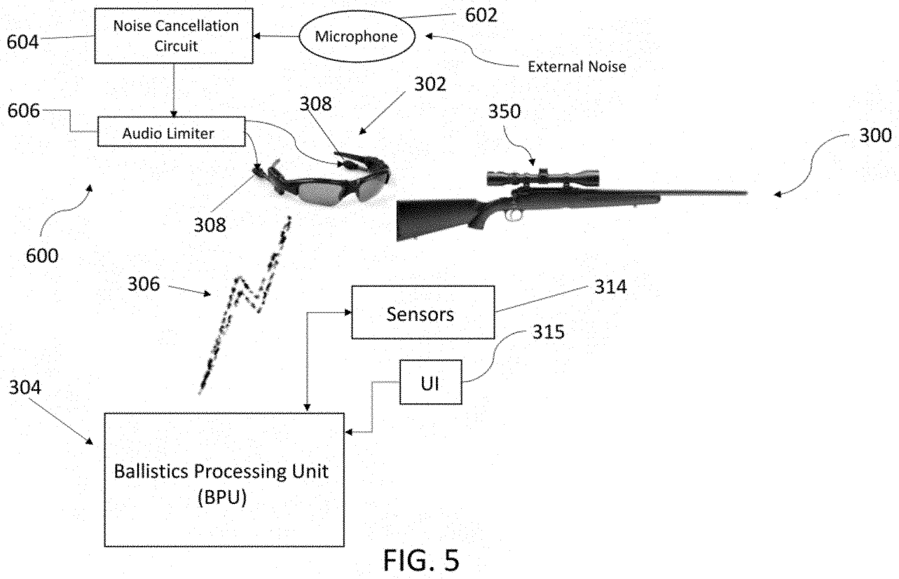

Referring to FIG. 6, further disclosure of ballistics processing unit 304 is provided. The exemplary computing environment shown in FIG. 6 typically includes at least one processing unit 318 and memory 320. Depending on the exact configuration and type of computing device used to implement ballistics processing unit 304, memory 320 may be volatile (such as RAM), non-volatile (such as ROM, flash memory, etc.), or some combination of the two. The most basic configuration of the ballistics processing unit 304 is illustrated in FIG. 6 by dashed line 322.

Ballistics processing unit 304 may include additional features/functionality. For example, ballistics processing unit 304 may also include additional storage. Such additional storage is illustrated in FIG. 6 by removable storage 324 and non-removable storage 326. Such computer storage media includes volatile and nonvolatile, removable and non-removable media implemented in any method or technology for storage of information such as computer readable instructions, data structures, program modules, or other data. Memory 320, removable storage 324, and non-removable storage 326 are all examples of computer storage media. Computer storage media includes, but is not limited to, RAM, ROM, EEPROM, flash memory, or other memory technology. Any such computer storage media may be part of ballistics processing unit 304.

Ballistics processing unit 304 may also contain communications connection(s) 328 that allows the ballistics processing unit to communicate with other devices, such as hands-free headset 302. Communications connection(s) 328, may include an audio/visual interface (the significant of which will be described below), as well as communication media. Communication media typically embodies computer readable instructions, data structures, program modules, audio recordings, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media.

Ballistics processing unit 304 may also include at least some form of computer readable media, which can be some form of computer program product. Computer readable media can be any available media that can be accessed by processing unit 318. By way of example, and not limitation, computer readable media may comprise computer storage media and communication media. Computer storage media includes volatile and nonvolatile, removable and non-removable media implemented in any method or technology for storage of information such as computer readable instructions, data structures, program modules, or other data. Combinations of any of the above should also be included within the scope of computer readable media.

In a contemplated embodiment, a ballistics program, including any data and/or executable software instructions providing ballistics information, is executed on the processing unit 318. In one example, a ballistics program may be implemented by reference to the Infinity Suite of exterior ballistics software offered by Sierra Bullets of Sedalia, Mo. Ballistics information is generally understood to be any data or information that describes the flight of a projectile, such as a bullet under the influence of environmental, gravitational, or other effects.

The ballistics information may be based on input information received about the mass of the bullet, the bullet's coefficient of drag or other ballistic coefficients, the muzzle velocity, humidity, barometric pressure, wind velocity, wind direction, altitude, angle of the shot, range, diameter of the bullet, and other considerations. As will appear, some or all of this input information can be used to determine characteristics of a bullet's flight.

In the contemplated embodiment, ballistics information may be calculated with the ballistics program stored in a look-up table. Thus, rather than continually calculating ballistics information on the fly, a set of ballistics information may pre-calculated for quick retrieval by the processor/controller 318.

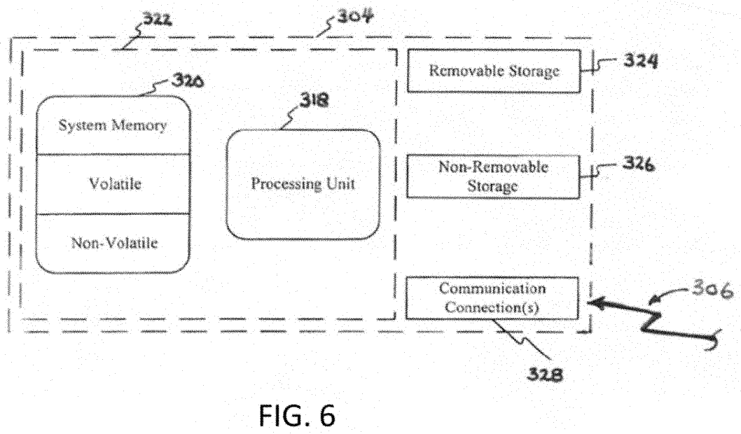

FIG. 7 shows an exemplary user communication model for use with system 300 where audio commands are transmitted from the headset 302 to an audio/visual interface 330 of communication connection(s) 328. The audio/visual interface 330 then processes the audio commands, generating a machine readable input for consumption by the ballistics processing unit 304. The audio/visual interface then can receive feedback from the ballistics processing unit 304, and thereby provide audible speech and/or image data back to the operator. In one example of use, a firing solution is requested by the operator of the ballistics processing unit 304, and hold-over/hold-off instructions are fed back to the hands-free headset 302.

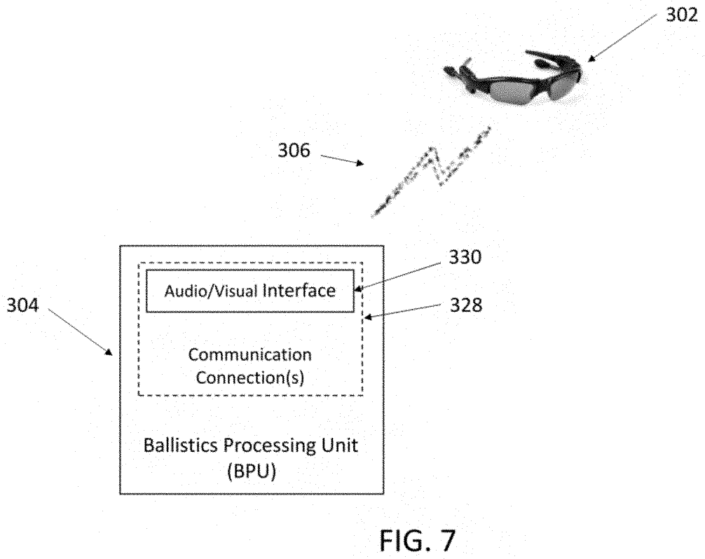

An exemplary program used in implementing the audio/visual interface 330 is illustrated in FIG. 8. Following the flow-diagram from “Audio In” (332) to “Audio/Image Out” (344), the audio/visual interface 330 would, in one example, receive audio input (typically, in terms of a string) [334] and convert the corresponding audio information into machine readable instructions (336 and 338). An exemplary lexicon, including exemplary audio commands suitable for use with the disclosed embodiments, including exemplary audio commands suitable for use with the disclosed embodiments, shown below in Tables 1 and 2 with legend, are described in further detail below.

TABLE 1
Administrative Commands

| | | Verbal Confirmation | Ballistics |
|---|---|---|---|
| | Verbal Confirmation enabled | Terse (Minimal | Calculator |
| Audio Commands | (Verbose) | Verbal Response) | Functionality |
| Distance Units: | Distance units yards | yards | Set the default |
| Yards | Distance units meters | meters | range units to |
| Distance Units: | | “No Matching | either yards or |
| Meters | | Units” | meters |
| | | “Command Not | |
| | | Recognized” | |
| Rifle: <verbal_ID> | Rifle <verbal_ID> selected | <verbal_ID> | Selects rifle from |
| | “No Matching Rifle” | “No Matching | pre-configured |
| | “Command Not Recognized” | Rifle” | library. Each rifle |
| | | “Command Not | entry and its |
| | | Recognized” | corresponding |
| | | | parameters are |
| | | | setup using a |
| | | | GUI/API interface. |
| Ammo: | Ammuniation <verbal_ID> | <audio_match> | Selects |
| <verbal_ID> | selected | | ammunition from |
| | “No Matching Ammunition” | | pre-configured |
| | “Command Not Recognized” | | library. Each |
| | | | ammunition entry |
| | | | and its |
| | | | corresponding |
| | | | parameters are |
| | | | setup using a |
| | | | GUI/API interface. |
| Log: On | “Text Logging enabled” | “Text Logging | digital text file |
| Log: Off | “Text Logging disabled” | enabled” | logging |
| | “Command Not | “Text Logging | |
| | Recognized” | disabled” | |
| | | “Command Not | |
| | | Recognized” | |
| Audio Log: On | “Bidirectional Audio | “Audio recording | logs all verbal |
| Audio Log: Off | recording enabled” | enabled” | commands and |
| | “Bidirectional Audio | “Audio recording | responses. |
| | recording disabled” | disabled” | |
| | “Command Not | “Command Not | |
| | Recognized” | Recognized” | |
| Require: Wind | “Wind Input Required” | “Wind Required” | Will not calculate |
| Require: Slope | “Slope Input Required” | “Slope Required” | firing solution |
| | “Command Not | “Command Not | unless wind and or |
| | Recognized” | Recognized” | slope are |
| | | | provided. |
| | | | Otherwise they |
| | | | are optional. |
| Confirmation: | Confirmation enabled | disabled | Sets the audio |
| enable | “Mode Not Recognized” | “Mode Not | response mode. |
| Confirmation: | “Command Not | Recognized” | There are three |
| terse | Recognized” | “Command Not | mode selections |
| Confirmation: off | | Recognized” | for verbal |
| | | | confirmation |
| | | | {enable, terse, |
| | | | off}. |
| Reset | Soft Reset Requested | <beep> | A Soft reset is |
| | | <Error_Tone> | equivalent to |
| | | | power on. |

TABLE 2
Active Solutions Commands

| | | Verbal Confirmation | Ballistics |
|---|---|---|---|
| | Verbal Confirmation enabled | Terse (Minimal | Calculator |
| Audio Commands | (Verbose) | Verbal Response) | Functionality |
| Range: | Range: | <distance_digit_string>, | Sets target range |
| <distance_digit_string> | <distance_digit_string>, | [down] | and returns reticle |
| | [down] | <elevation_digit_string> | holds. |
| | <elevation_digit_string> | <distance_digit_string>, | Distance Units |
| | Range: | [down] | are preconfigured. |
| | <distance_digit_string>, | <elevation_digit_string> | The “Range” |
| | [down] | <left, right> | operator will |
| | <elevation_digit_string> | <windage_digit_string> | attempt to |
| | <left, right> | | provide a solution |
| | <windage_digit_string> | | depending on |
| | | | what input is |
| | | | provided. |
| | | | The only time |
| | | | only time the |
| | | | input range is |
| | | | echoed is when no |
| | | | Ammo has been |
| | | | selected. |
| | | | No “Up” |
| | | | elevation modifier |
| | | | is provided in the |
| | | | “Terse” and |
| | | | “Disabled” modes. |
| Store <verbal_ID> | <verbal_ID> Stored | Stored | Store All Input |
| | | | with verbal key |
| | | | into the package |
| | | | library for later |
| | | | recall. Does not |
| | | | include |
| | | | administrative |
| | | | commands. |
| Recall <verbal_ID> | <verbal_ID> Recalled | <verbal_ID> | Recall a “pacakge” |
| | <verbal_ID> Recalled, | Recalled | with verbal key. If |
| | Range: | <verbal_ID> | a solution can be |
| | <distance_digit_string>, | Range: | provided one is |
| | [down] | <distance_digit_string>, | supplied. |
| | <elevation_digit_string> | [down] | |
| | <verbal_ID> Recalled, | <elevation_digit_string> | |
| | Range: | <verbal_ID> | |
| | <distance_digit_string>, | Range: | |
| | [down] | <distance_digit_string>, | |
| | <elevation_digit_string> | [down] | |
| | <left, right> | <elevation_digit_string> | |
| | <windage_digit_string> | <left, right> | |
| | | <windage_digit_string> | |
| Slope: <digit | Slope <digit string> degrees | <digit string> | Sets slope angle |
| string> | | degrees | from gravitational |
| | | | level |
| Max Elevation: | Max Elevation: | Max: | Safety measure to |
| <elevation_digit_string> | <elevation_digit_string> | <elevation_digit_string> | make sure no |
| | | | solution sends a |
| | | | round off the |
| | | | range. |
| Wind: <digit | Wind <digit string> <mph, | <digit string> <mph, | Sets wind velocity |
| string>from: | m/s> from <clock_codes> | m/s> from | and direction |
| <clock_codes> | | <clock_codes> | relative to |
| | | | projectile flight |
| | | | path |
| Ready | Hold over | <elevation_digit_string>, | Shooter ready for |
| Shooter Ready | <elevation_digit_string>, | <left, right> | solution. |
| Splash | Hold <left, right> | <windage_digit_string> | |
| | <windage_digit_string> | Missing [Rifle, | |
| | Missing [Rifle, Ammunition, | Ammunition, | |
| | [Wind], [Slope]] | [Wind], [Slope]] | |
| Call Wind | Call Wind String <digit | | Stream of wind |
| | string>, <digit string>, <digit | | calls provided by |
| | string>, <digit string>, . . . | | system |
| Stop | All Stop | <beep> | Dynamic wind |
| | | | calling audio |
| | | | stream |
| | | | aborted/stopped |
| Solve Target <mil | Target <target_name> <mil | | calculates range |
| string/moa string> | string/moa string> <mils, | | estimation based |
| | moa> | | on target size and |
| Repeat | <last_audio_response> | | Repeat the last |
| | | | audio response |
| | | | from the VxAB |
| | | | system |
| UKDTarget | <size_digit_string> Target | <size_digit_string> | Shooter provides |
| <size_digit_string> | Measured at <mil string/moa | Target at <mil | object dimension |
| reticle <mil | string> <mils, moa> | string/moa string> | followed by |
| string/moa string> | | | measurement |
| | | | display in the |
| | | | reticle. |
| Max Windage | Max Windage | Max | Safety measure to |
| <windage_digit_string> | <windage_digit_string> | <windage_digit_string> | make sure no |
| | | | solution sends a |
| | | | round off the |
| | | | range. |
| Target | Target <target_name> | loaded | Set target |
| <target_name> | loaded | | dimensions[wxh] |
| | | | for range |
| | | | estimation |
| Clear Solution | “range, slope, target, and | “All input cleared” | Clears data used |
| | wind input cleared.” the | “Command Not | to calculate a |
| | elevation and windage are set | Recognized” | solution. The |
| | to null. | | elevation and |
| | “Command Not | | windage are set to |
| | Recognized” | | null. |
| Magnification | | | |
| <digit string> | | | |
| Start | <audio_start_beep> | | Lead calculator |
| | | | marks start time. |
| | | | Notes target |
| | | | entrance into field |
| | | | of view. |
| Stop | Lead | Lead | If moving timer is |
| | <windage_digit_string> | <windage_digit_string> | activated for a |
| | | | known target size |
| | | | a lead is provided |
| | | | with wind |
| | | | adjustments |
| | | | applied. |
| Open | Open <digit_String> | | |
| <digit_String> | | | |
| Closed | Closed <digit_String> | | |
| <digit_String> | | | |
| Query Rifle | Rifle <Rifle_verbal_ID> | <Rifle_verbal_ID> | Provide current |
| Query Ammo | selected | <Ammo_verbal_ID> | value for input |
| Query | Ammuniation | <digit string> | specified. |
| Magnification | <Ammo_verbal_ID> selected | <digit string> from | |
| Query Wind | Magnification <digit string> | <clock_codes> | |
| Query Range | power | <distance_digit_string> | |
| Query Target | Wind <digit string> <mph, | <Target_verbal_ID> | |
| Query Slope | m/s> from <clock_codes> | Sames as Verbose. | |
| Query Pacakge | Range: | | |
| | <distance_digit_string> | | |
| | <yards/meters> | | |
| | Target <Target_verbal_ID> | | |
| | selected | | |
| | Slope <digit string> | | |
| | provide all of the above | | |
| | information. | | |

### Legend for Tables 1 and 2

<verbal_D>: An user selected verbal identifier. Name of a gun, ammunition, a target, or saved solution. Allows for library references to be recalled quickly.
<digit string>: 0-1-2-3-4-5-6-7-8-9-point. [digits[.]digit[digit]] [break].
<clock_codes>: 1, 130, 2, 230, 3, 330, 4, 430, 5, 530, 6, 630, 7, 730, 8, 830, 9, 930, 10, 1030, 11, 1130, 12, 1230.
<distance_digit_string>: <digit string>
<elevation_digit_string>: <digit string>
<windage_digit_string>: <digit string>
<target_name>: <verbal_ID>
<last_audio_response>: last verbal command identified by the software,
“Shooting Scenario”: Include all input required to determine a solution except rifle and ammunition. Administrative settings are unchanged.

At 340 and 342, the machine readable instructions are communicated to the basic configuration 322 of ballistics processing unit 304 (FIG. 6) for possible feedback from the ballistics processing unit.

Responsive to feedback from the ballistics processing unit, appropriate interpretation (of, for instance, a command) is performed at 344 and, in turn, via 346 and 348, the machine readable output is converted into a response by the audio/visual interface 330 for communication to the hands-free headset 302 for use by the operator. If the ballistics processing unit is nonresponsive (possibly due to erroneous input at 332), then the process loops back to 332 for additional input.

In an exemplary embodiment described below, feedback may be provided to the operator in terms of an audio tone, as well as verbal or imaginal feedback. In one instance of the exemplary embodiment, audio feedback is communicated to the operator in a default mode, and imaginal feedback may be communicated to the operator when the system detects that the operator is wearing smart glasses (also referred to as “heads up display”). Further disclosure regarding audio/visual interfaces and their respective uses in processing inputs/outputs as well as coordinating tasks is provided in U.S. Pat. Nos. 8,260,618; 8,700,405; 9,112,972; and U.S. Patent Application Publication No. 2008/0037727; the entire disclosures of which are incorporated herein by reference.

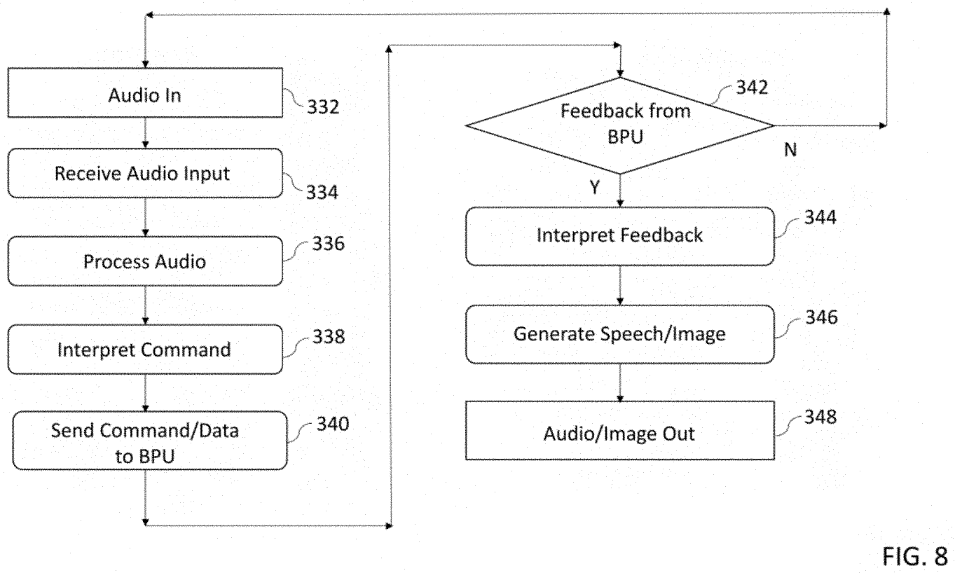

It will be appreciated by those skilled in the art that the above-described processing platform of system 300, namely ballistics processing unit 304, can be generalized as one of several architectures. One such architecture is shown in FIG. 9, and, as contemplated, this architecture can be implemented on a one of several commercially available portable computing platforms (including, but not limited to, a smart phone, portable lightweight computer, tablet, or PDA). Consistent with the description of U.S. Patent Application Publication No. 2014/0324348, the entire disclosure of which is incorporated herein by reference, the multi-vendor object architecture for voice-activated ballistics of the disclosed architecture may be implemented with an application programming interface (API) and/or a service layer.

The API may include specifications for routines, data structures, and object classes. The API may be either computer language independent or dependent and refer to a complete interface, a single function, or even a set of APIs. The 3^{rd} party ballistic solver processor of the disclosed architecture may be implemented with one of several commercially available applications. The various objects, the significance of which will appear from the description below, may be stored in the ballistics processing unit 304 (in memory 320 and/or removable storage 324) [FIG. 6] or even offline at server 310 (FIG. 5).

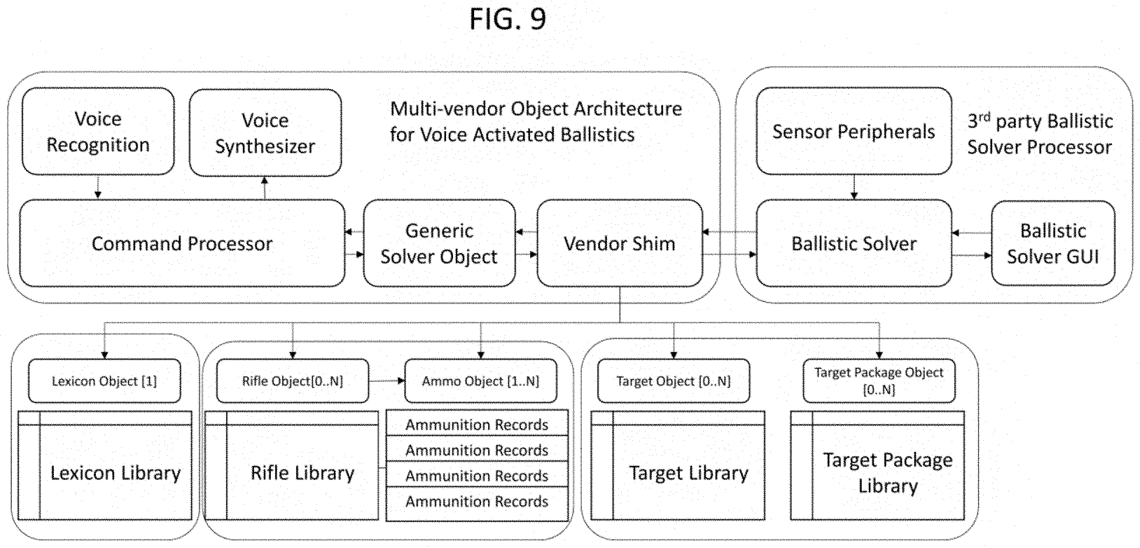

Referring to FIG. 10 as well as Tables 1 and 2, an overview of an exemplary application operable with the system 300 to obtain a firing solution (i.e., important information required for aiming a firearm) is shown. In one embodiment, the operator communicates administrative and solution commands to the ballistics processing unit 304 by way of the audio/visual interface 330. The administrative commands comprise verbal commands necessary to configure a verbal processor, while solution commands comprise those commands necessary to generate a suitable firing solution. While verbal commands are generally contemplated for use with the system 300, in one example, administrative commands may be entered with UI 315. The employment of administrative and solution commands underlie the overview of FIG. 10 and will be discussed in further detail below.

Referring still to FIG. 10, at 410, 412 and 414, certain preliminary or administrative requirements are addressed. In one example, the operator initially provides a command at 410 for selecting a rifle type. As will be discussed in further detail below, an acceptable command for 410 will be recognized by the ballistics processing unit 304 if it is both in accord with the formatting of the lexicon of Table 1 and corresponds with a rifle type listed in the Rifle Library object (FIG. 9). The situation at 412 is similar to that at 410, except the command at 412 is used to select ammunition type for the rifle selected at 410.

At 414, dynamic factors and conditions, such as temperature humidity, barometric pressure, density altitude, location coordinates, or orientation to magnetic north may be inputted to the ballistics processing unit 304 either through use of verbal commands (through use of audio/visual interface 330), sensors 314 or UI 315. An inquiry to determine if all of the information required for 410, 412 and 414 has been provided, and thus if the process is ready to receive active solution commands, is performed at 416.

Upon obtaining a positive response to the inquiry of 416, the process proceeds to 418 for verbally recalling, changing, or inputting remaining factors and conditions, and to 420 for requesting a firing solution. Once it is determined, via inquiry 422, that all input necessary for generating a firing solution has been obtained, ballistics processing unit 304 communicates a verbal/imaginal firing solution (including, for instance, hold-over and hold-off information) to the hands-free headset 302.

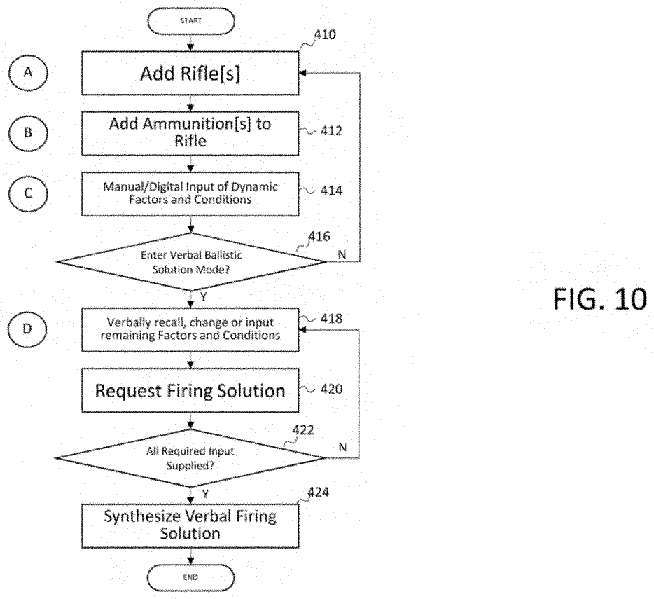

In one exemplary approach, the application of FIG. 10 is implemented with an object-oriented design model, shown in FIG. 11, with the object-oriented design being executed on the architecture of FIG. 9. Pursuant to executing the model, commands from the operator required to generate a firing solution are temporarily stored in the Command Line Buffer 428. The Command Line Buffer, in one example, is merely a string buffer collecting strings returned from the Voice Recognition Object (FIG. 9) before a delimiter is reached. The rest are object references which constitute settings, factors, and conditions required to execute subsequent commands.

As follows from the model of FIG. 11, the exemplary application of FIG. 10 is implemented with runtime state information. For the exemplary implementation of FIG. 11, a Current Settings Object, designated by the numeral 430, contains application options used to configure the application of FIG. 10 to the firearm operator's preferences. Data for the Current Settings Object 430 may be stored in non-volatile memory so that settings are retained on power on/off cycles.

For the exemplary implementation of FIG. 11, a Current Conditions Object, designated by the numeral 432, contains environmental data required to determine a firing solution. This data, which may be volatile and dynamic, can be supplied verbally [or with sensors] by the operator or via the 3^{rd} party ballistic solver processor of FIG. 9.

For the exemplary implementation of FIG. 11, a Current Target Package Object, designated by the numeral 434, contains some static data required to calculate a firing solution. As will be described in further detail below, a “Store” command may be employed to add data to the Current Target Package Object, associating a “verbal_id” with each package for subsequent “Recall.” The Target Package Library Object (FIG. 9) can be used to enumerate the complete set of stored target packages for verbal recall and/or editing (including verbal editing with optional visual display).

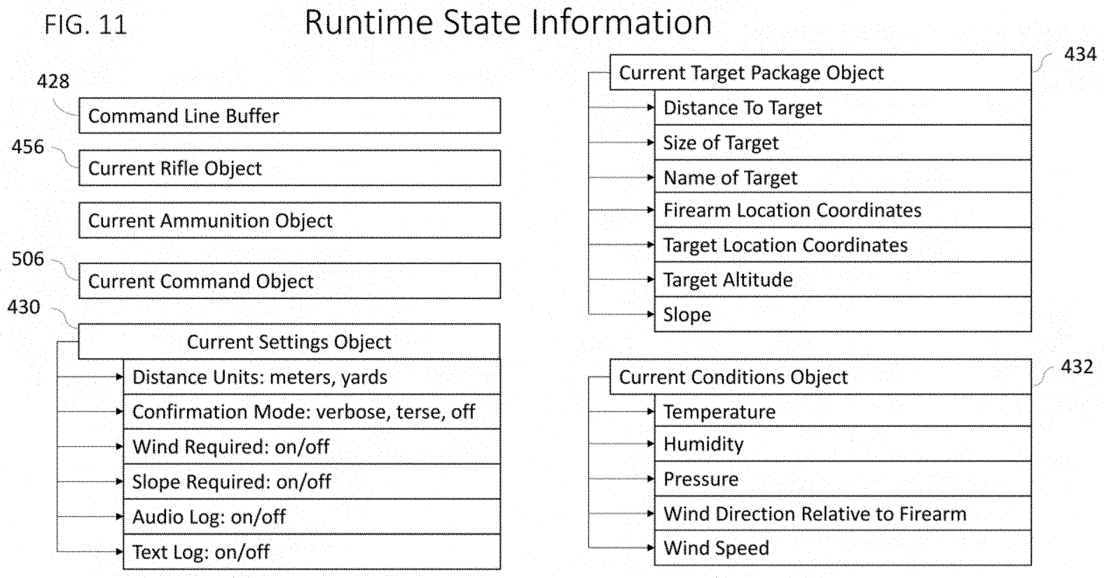

In the exemplary application of FIG. 10, certain inputs, such as rifle and ammunition selections, as well as manual/digital input of dynamic factors and conditions, have been designated as being minimally required. Referring to FIG. 12 to FIG. 14, exemplary processes for gathering these inputs is described:

Referring to FIG. 12, an approach for adding a rifle object to the Rifle Library of FIG. 9 is shown. In the illustrated example of FIG. 12, a verbal digital rifle name string (assuming the form of “verbal_id” per Table 1) is entered at 438. Assuming the rifle name string is unique (see inquiry 440) [i.e., not already assigned to an existing entry in the Rifle Library] the voice recognition object (FIG. 9) is consulted (via inquiry 442]) to verify only one library entry is identified. In the illustrated example, the operator is asked to state the rifle name into the microphone of the hands-free headset 302 and to confirm a match. If a reliable verbal name lookup can be confirmed, the operator is then prompted, via 444, 446, 448, 450 and 452 to enter data (relating to the selected rifle) usable in calculating a firing solution. Per 454, the selected rifle, along with corresponding data, becomes part of the Current Rifle Object 456 (of FIG. 11).

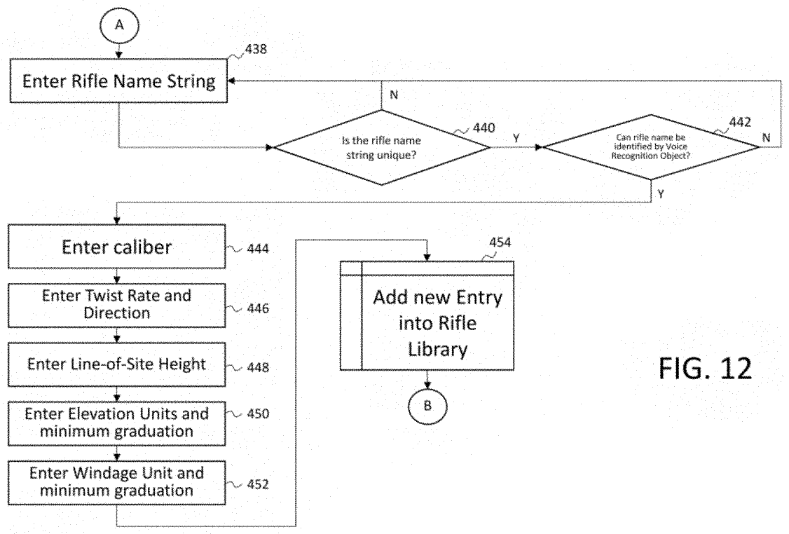

As illustrated in FIG. 13, the overall approach for adding a Current Ammunition Object 460 (corresponding with the Current Rifle Object) is similar to that shown in FIG. 12. That is, an ammunition string name is entered at 462. Assuming the ammunition (“Ammo”) name string is unique, with respect to the Current Ammunition Object (see inquiry at 464) and a reliable verbal name lookup can be confirmed for the entered Ammo name string [see inquiry 466], then the operator is prompted, via 468, 470, 472, 474, 476, 478, 480 and 482 to enter data (relating to the selected rifle and ammunition) usable in calculating the firing solution. Per 484, an Ammunition Record is added to and associated with a single Current Rifle Object 456 (of FIG. 11).

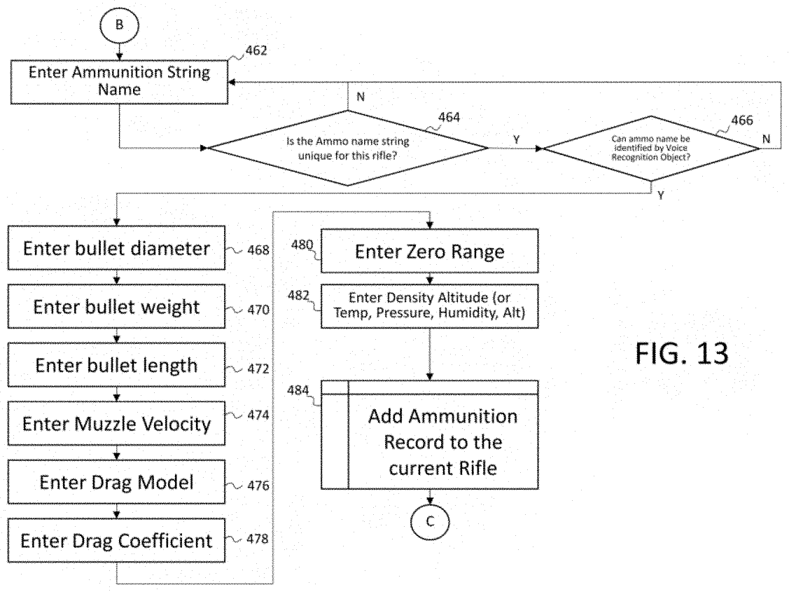

As illustrated in FIG. 14, verbal or digital values for Altitude, Temperature, Humidity Atmospheric Pressure, and Firearm Location Coordinates may be inputted to the ballistics processing unit 304 by way of 488, 490, 492, 494, and 496. Input may be obtained from any one of several sources, such as hands-free headset 302, sensors 314, or user interface 315, by way of wired, wireless, and/or networked connections. Moreover, Firearm Location Coordinates may include GPS coordinates. The inquiry at 498 is used to determine if target coordinates are known to the operator. If the respective location coordinates of each one of the firearm and the target location are known, then distance to the target can be calculated (500) and, if the target location coordinates are not known then, alternatively, distance to the target can be inputted directly (502). It should be appreciated that, in an alternative embodiment, target distance can be calculated in response to the operator providing an object dimension of a target (e.g., “Target Size: Elk”) followed by a measurement from a graphic display of a rifle scope. An example of this type calculation is disclosed in U.S. Patent Application Publication No. 2016/0245619, the entire disclosure of which is incorporated herein by reference.

Several features follow from the use of the architecture of FIG. 9 in conjunction with the lexicon of Tables 1 and 2.

First, it should be apparent that the operator can refine the calculation of the firing solution by calling out several commands that have not been specifically discussed with respect to the object-oriented model of FIG. 11 (but generated in accordance with the Current Command Object 506). For example, a value for wind velocity may be set with a Wind command and/or inferred from a series of wind velocity rates inputted by way of a Call Wind command.

Second, certain functionality provided by the lexicon facilitates user operation. For example, a series of Query commands, along with a Repeat command, permits for audio verbal feedback of data previously inputted by the operator.

Third, the operator can choose from three feedback modes so that the time required to perform the aiming process may be shortened, as desired. For example, the operator may choose to receive a verbal confirmation that is either reasonably complete (maybe even slightly verbose), reasonably minimal (possibly somewhat terse) or extremely terse. Additionally, in the extremely terse case (which is not shown in Tables 1 or 2), confirmation of an operation may be indicated with a simple sound (such as a beep) while failure to perform the operation may be indicated with an error.

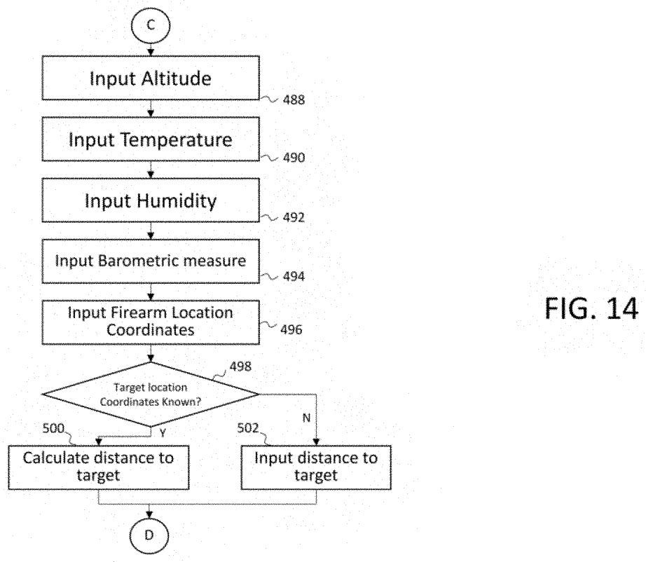

Referring now to FIG. 9, FIG. 10, FIG. 15 as well as Tables 1 and 2, a control loop for voice activated ballistics is shown. In particular, at 510, the voice recognition object returns a string. A verbal or time limiter is sought at 512. A single command may be associated with a verbal or time delimiter the verbal delimiter may include a key word, such as “break” or “over,” while the time limit may be configured to denote the end of command string sequence. If a delimiter is not reached, the string is post-pended to the Command Line Buffer 428 (FIG. 11). At 514, the string in the command line buffer is parsed and formatted for individual words and numbers. This should improve probability of correct command identification and restatement on verbose verbal responses. At 516, the lexicon library is searched for a matching command. A Command Object returned with 516 becomes the Current Command Object 506 (FIG. 11); otherwise, an error message is generated at 520.

In the event the command is recognized at 518, the remaining command string buffer is parsed by the Command Object (at 522) and any parameters are included in the Runtime State Data (of FIG. 11). Referring still to FIG. 15, at 426, the process determines whether the parameters necessary to support the current command object are valid/available. If the parameters are invalid/unavailable, the failure response of 520 is generated; otherwise, the Current Command Object 506 is executed, at 526, using information in the runtime state. In the event of execution, the Current Command Object is consulted to obtain an appropriate response to the operator. In turn, a verbal or tonal computer-generated response may be provided (530) using the audio/visual interface 330.

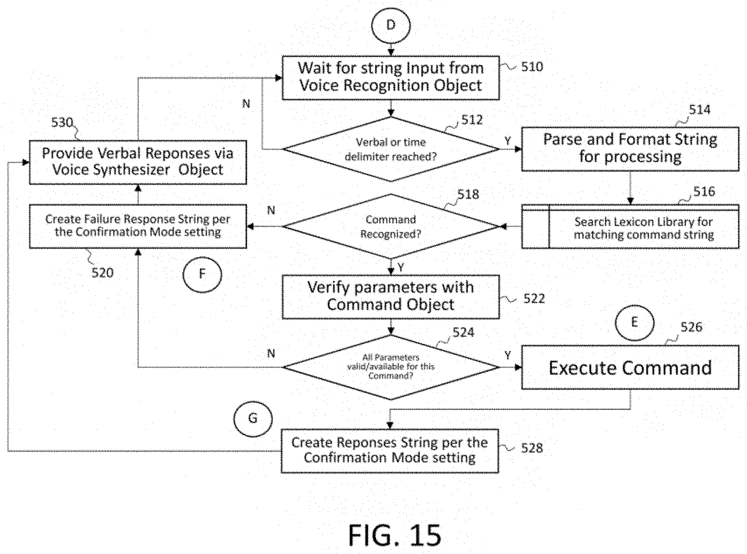

It should now be apparent to those skilled in the art that the system 300 can be advantageously used to easily generate target packages with verbal commands. Referring to FIG. 16, an exemplary process for storing a target package is shown. The functionality of 534 and 536 ensure that the verbal_id assigned to each entry being stored can be recalled. At 538, an analysis is performed to determine whether the target package being saved includes a minimal set of information. For each of 534, 536 and 538, if minimal entries are not present, then the process is directed to 520 of FIG. 15 (at “F”), namely the error logic path. If it is determined, at 538, that minimal entries are present, then the Current Target Package Object 434 (FIG. 11) is passed to the Target Library Object (FIG. 9) so all information can be stored in non-volatile memory. If 540 is successful, main control loops successful execution logic path (designated as “G” in FIG. 15) is taken.

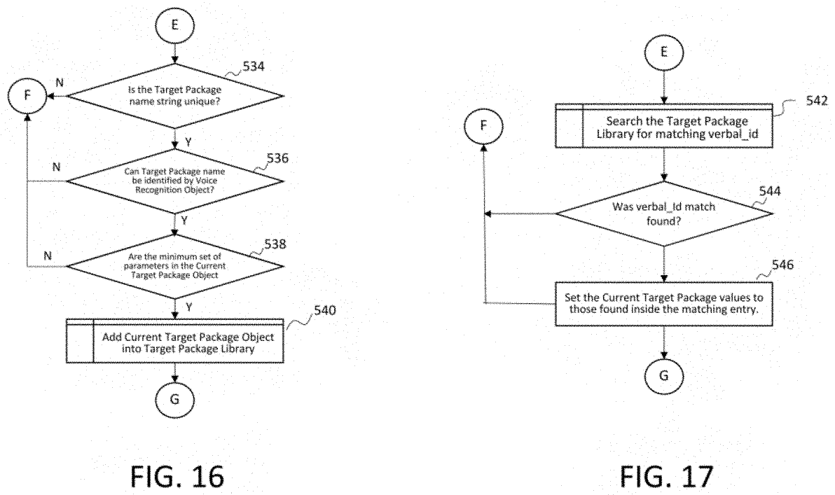

Referring to FIG. 17, an exemplary process for recalling a target package is shown. At 542, the Target Package Library (FIG. 9) is searched for matching verbal_id found in the command line buffer string. If a verbal_id match cannot be found (via the search of 544) then the main control loops error logic path (in FIG. 15) is taken; otherwise the Current Target Package values in the run time state are set to those found inside the matching library entry.

It should also now be apparent to those skilled in the art that the system 300 permits an operator to obtain a firing solution as the operator moves from one physical location to another without requiring any sort of tactile input. In one example, the operator can merely recall a pre-stored target package corresponding (at least partially) with a new location to which an operator has moved. Alternatively, the operator can provide verbal information (in audio form or by an attached position sensor) about a new location and dynamically obtain an appropriate firing solution in a completely hands-free manner.

Referring again to FIG. 5, in one exemplary implementation the headset 302 is operatively associated with an audio limiting device 600. A description of an audio limiting device for use with headphones 302 in cancelling loud noises, such as a gunshot, is disclosed in U.S. Patent Application Publication No. 2007/0230715, the entire disclosure of which is incorporated herein by reference.

Further associated disclosure is provided in U.S. Pat. No. 7,110,558, the entire disclosure of which is incorporated herein by reference. In one example of implementation, audio limiting device includes a microphone 602 communicating with a noise cancellation circuit 604. The noise cancellation circuit 604 communicates with speakers 308 by way of an audio limiter 606. In operation, when an excessively loud noise, such a gunshot, is detected with the noise cancellation circuit, corresponding audio output from the noise cancellation circuit is lowered by the audio limiter so that the audio output transmitted to the speakers 308 is maintained at a safe level for the operator.

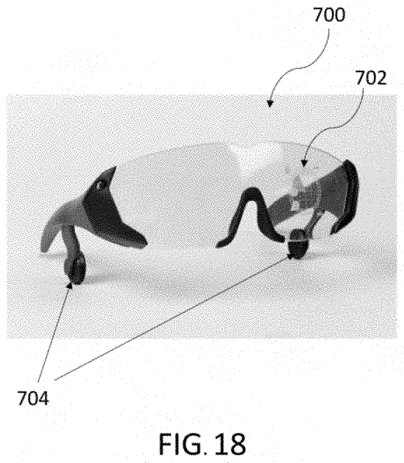

As discussed above, the system 300 can be used to provide an operator with verbal instructions for aiming and/or an imaginal overlay including, in one example, with a firing solution. For instance, the imaginal information may be displayed by way of a hands free headset comprising either “smart glasses” or heads up display (HUD) glasses (or, alternatively, a HUD monocular piece). Referring to FIG. 18, a pair of HUD glasses or goggles, designated by the numeral 700, is shown with a display portion 702. Additionally, a microphone and earphones may be provided by input/output devices 704. HUD glasses (and associated circuitry) suitable for use as HUD glasses 700 are disclosed in U.S. Patent Application Publication No. 2014/0240313 and U.S. Pat. No. 6,085,428, the entire disclosures of which are incorporated herein by reference. Image data may be communicated from the audio/visual interface 330 (FIG. 7) to the display portion headset 700 by way of wired, wireless or networked connections.

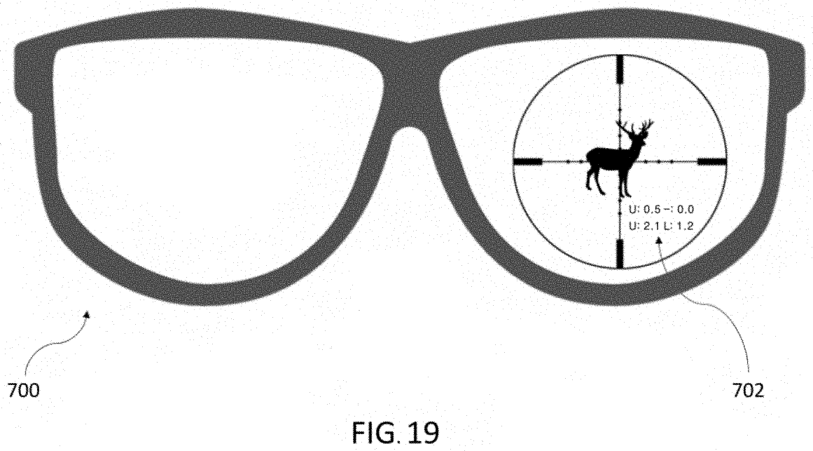

Referring to FIG. 19, the use a pair of HUD glasses with the system 300 can be better understand. In particular, when the ballistics processing unit 304 detects that HUD glasses 700 (or the like) are in use, image data generated at 342 (per the process of FIG. 8) is transmitted to the glasses 700 for display at display portion 702. In turn, the display portion 702 can be positioned adjacent the ocular lens of the scope 350 (FIG. 5 and FIG. 19). As shown in FIG. 19, information corresponding with the firing solution overlays the view into the scope 350 for convenient reference by the operator. It should be appreciated that the exemplary embodiment of FIG. 19 could be implemented with a monocular device since only one lens of goggles is typically required to assist in the sighting process.

Additionally, it should be appreciated that the glasses 700 can be advantageously used with inexpensive, even legacy rifle scopes since the disclosed overlay approach does not require any costly imaging devices mechanically attached to the firearm.

The disclosed embodiments include an apparatus for assisting an operator in aiming a firearm with a sighting scope. The apparatus includes; a hands-free communications device including both an input device for generating an audio input and an output device for receiving a set of information, the set of information being usable by the operator for aiming the firearm; a ballistics processing unit, the ballistics processing unit (i) receiving a machine readable input and (ii) generating machine readable output, the machine readable output corresponding with the set of information usable by the operator for aiming the firearm with the sighting scope; and an audio/visual interface, communicatively coupling said hands-free communication device and said ballistics processing unit, the audio interface (i) converting the audio based input generated with said hands-free communications device into the machine readable input, (ii) converting the machine readable output generated with the ballistics processing unit into the set of information usable by the operator for aiming the firearm with the sighting scope, and (iii) communicating the set of information usable by the operator for aiming the firearm with the sighting scope from the audio/visual interface to said hands-free communications device.

The set of information usable by the operator for aiming the firearm with the sighting scope may be communicated to the hands-free communications device in an audio verbal format.

The set of information usable by the operator for aiming the firearm with the sighting scope may be communicated to the hands-free communications device in the form of one or more audible tones.

The hands-free communication device may comprise a pair of wearable glasses with the pair of wearable glasses including a display portion, and the set of information usable by the operator for aiming the firearm with the sighting scope may include a set of image data.

In turn, the image data may be used to display at least part of the set of information for use by the operator in aiming the firearm with the sighting scope on the display portion.

The hands-free communication device may be operatively associated with a Bluetooth enabled system.

The hands-free communication device may be operatively associated with a noise filtering system, the noise filtering system at least partially blocking noise, generated as a result of shooting the firearm, from being transmitted to the operator.

The sighting scope may include a graphic image pattern for aiming the firearm at an object, and the set of information usable by the operator for aiming the firearm may comprises an audible firing solution. The audible firing solution can be used with the graphic image pattern to position the firearm with the sighting scope.

The apparatus may include a library having a plurality of formatted terms. The ballistics processing unit may use the formatted terms to generate the set of information usable by the operator for aiming the firearm with the sighting scope. At least part of the set of information usable by the operator for aiming the firearm with the sighting scope may be created in response to matching a command communicated from the hands-free communication device with one of the formatted terms of the library.

The apparatus may further include a memory disposed remotely of the firearm. The set of information usable by the operator for aiming the firearm with the sighting scope may be stored in the memory disposed remotely of the firearm, and the machine-readable input may include one or more instructions with the one or more instructions being used to develop at least part of the set of information usable by the operator for aiming the firearm with the sighting scope.

The set of information usable by the operator for aiming the firearm with the sighting scope may include at least one of a parameter and data and be retrieved from the memory disposed remotely of the firearm with the sighting scope. The at least one of the parameter and the data may be edited in response to operator input.

Additionally, the set of information usable by the operator for aiming the firearm with the sighting scope may be stored in the memory disposed remotely of the firearm subsequent to editing the at least one of the parameter and the data.

A plurality of information sets usable by the operator for aiming the firearm are stored in memory disposed remotely of the firearm, and an instruction may be used to retrieve one of the plurality of information sets for use by the operator in aiming the firearm.

The set of information usable by the operator for aiming the firearm may be communicated to the operator in one of at least two selectable audible playback modes. The at least two selectable audible playback modes may correspond respectively with a first playback length and a second playback length—in one example of operation, the first playback length is longer than the second playback length.

A set of windage related information may be communicated to the ballistics processing unit, at which windage compensation feedback may be generated. The set of information usable by the operator for aiming the firearm with the sighting scope may include this windage compensation feedback.

The disclosed embodiments include a method for assisting a sighting operation by an operator with a firearm. The method includes receiving, at an audio recognition device, an audio based command from a hands-free communications device; using the audio recognition device to convert the audio based command into a machine-readable command, wherein the machine-readable command is associated with at least one parameter; using a ballistics processing device to (i) search a library of pre-formatted commands to determine if a match exists between the machine-readable command and one of the pre-formatted commands, and (ii) determine whether a selected relationship, warranting execution of the machine readable command by the ballistics processing device, exists between the at least one parameter and the machine readable command; and responsive to finding a match between the machine-readable command and one of the pre-formatted commands as well as determining that a the selected relationship exists between the at least one parameter and the machine-readable command, executing the machine readable command to generate a machine readable response.

The method may further include converting the machine-readable response to at least one of an audio response and image data; and transmitting the at least one of the audio response and image data to the hands-free communications device for use by the operator in performing the sighting operation with the firearm. The converting of the machine-readable response may include converting the machine-readable response to at least one of an audio response and image data; and the at least one of the audio response and image data may be transmitted to the hands-free communications device for use by the operator in performing the sighting operation with the firearm. In one example the machine-readable response comprises an audio response, with the audio response being transmitted to the hands-free communication device. In another example, the machine-readable response comprises image data, with the image data being transmitted to the hands-free communication device for display at the hands-free communications device. In yet another example, both of the audio response and the image data may be transmitted to the hands-free communications device for simultaneous use of the audio response and the image data with a firearm sighting scope.

A machine-readable response may be recalled from memory for converting the machine-readable response to at least one of an audio response and image data; and transmitting the at least one of the audio response and image data to the hands-free communications device for use by the operator in performing the sighting operation with the firearm.

In another example, the machine-readable response is editable and editing of the machine-readable response may be performed prior to converting the machine-readable response to at least one of an audio response and image data; and/or transmitting the at least one of the audio response and image data to the hands-free communications device for use by the operator in performing the sighting operation with the firearm.

The method may further include at least partially blocking noise generated as a result of shooting the firearm from being communicated to the hands-free communication device.

The method may yet further include transmitting the machine-readable response to the hands-free communication device in one of a first playback mode having a first playback length and a second playback mode having a second playback length, wherein the first playback length is longer than the second playback length.

An apparatus for assisting an operator in aiming a firearm with a sighting scope includes a hands-free communications device including both an input device for generating an audio input and an output device for receiving a set of information, the set of information being usable by the operator for aiming the firearm; a ballistics processing unit, the ballistics processing unit (i) receiving a machine-readable input and (ii) generating machine readable output, the machine readable output corresponding with the set of information usable by the operator for aiming the firearm with the sighting scope; and an audio/visual interface, communicatively coupling the hands-free communication device and the ballistics processing unit, the audio interface (i) converting the audio based input generated with the hands-free communications device into the machine readable input, (ii) converting the machine readable output generated with the ballistics processing unit into the set of information usable by the operator for aiming the firearm with the sighting scope, and (iii) communicating the set of information usable by the operator for aiming the firearm with the sighting scope from the audio/visual interface to the hands-free communications device.

The set of information usable by the operator for aiming the firearm with the sighting scope may be communicated to the hands-free communications device in an audio verbal format. The set of information usable by the operator for aiming the firearm with the sighting scope may be communicated to the hands-free communications device in the form of one or more audible tones.

The hands-free communication device may include a pair of wearable glasses with the pair of wearable glasses including a display portion, the set of information usable by the operator for aiming the firearm with the sighting scope includes a set of image data, and the image data is used to display at least part of the set of information for use by the operator in aiming the firearm with the sighting scope on the display portion.

The hands-free communication device may be operatively associated with a low power wireless communication system. The hands-free communication device may be operatively associated with a noise filtering system, the noise filtering system at least partially blocking noise, generated as a result of shooting the firearm, from being transmitted to the operator.

The sighting scope may include a graphic image pattern for aiming the firearm at an object, wherein the set of information usable by the operator for aiming the firearm comprises an audible firing solution with the audible firing solution being usable with the graphic image pattern to position the firearm with the sighting scope.

The apparatus may further include a library including a plurality of formatted terms, wherein the ballistics processing unit uses the formatted terms to generate the set of information usable by the operator for aiming the firearm with the sighting scope. The apparatus may further include memory disposed remotely of the firearm, wherein the set of information usable by the operator for aiming the firearm with the sighting scope is stored in the memory disposed remotely of the firearm, and wherein the machine-readable input includes one or more instructions with the one or more instructions being used to develop at least part of the set of information usable by the operator for aiming the firearm with the sighting scope. At least part of the set of information usable by the operator for aiming the firearm with the sighting scope may be created in response to matching a command communicated from the hands-free communication device with one of the formatted terms of the library.

The set of information usable by the operator for aiming the firearm with the sighting scope may include at least one of a parameter and data, wherein: the set of information usable by the operator for aiming the firearm with the sighting scope is retrieved from the memory disposed remotely of the firearm, and the at least one of the parameter and the data is edited in response to operator input. The set of information usable by the operator for aiming the firearm with the sighting scope may be stored in the memory disposed remotely of the firearm subsequent to editing the at least one of the parameter and the data.

A plurality of information sets usable by the operator for aiming the firearm may be stored in the memory disposed remotely of the firearm, wherein an instruction, in addition to the one or more instructions, is used to retrieve one of the plurality of information sets for use by the operator in aiming the firearm. The set of information usable by the operator for aiming the firearm may be communicated to the operator in one of at least two selectable audible playback modes. At least two selectable audible playback modes may correspond respectively with a first playback length and a second playback length, wherein the first playback length is longer than the second playback length.

A set of windage related information may be communicated to the ballistics processing unit, wherein the ballistics processing unit generates windage compensation feedback, and wherein the set of information usable by the operator for aiming the firearm with the sighting scope includes the windage compensation feedback.

A method for assisting a sighting operation by an operator with a firearm includes (a) receiving, at an audio recognition device, an audio based command from a hands-free communications device; (b) using the audio recognition device to convert the audio based command into a machine-readable command, wherein the machine-readable command is associated with at least one parameter; (c) using a ballistics processing device to (i) search a library of pre-formatted commands to determine if a match exists between the machine-readable command and one of the pre-formatted commands, and (ii) determine whether a selected relationship, warranting execution of the machine readable command by the ballistics processing device, exists between the at least one parameter and the machine readable command; and (d) responsive to finding a match between the machine-readable command and one of the pre-formatted commands as well as determining that the selected relationship exists between the at least one parameter and the machine-readable command, executing the machine readable command to generate a machine readable response.

The method may include (e) converting the machine-readable response to at least one of an audio response and image data; and (f) transmitting the at least one of the audio response and image data to the hands-free communications device for use by the operator in performing the sighting operation with the firearm.

The machine-readable response may be converted to an audio response, and the audio response may be transmitted to the hands-free communication device. The machine-readable response may be converted to image data, and the image data may be transmitted to the hands-free communication device for display at the hands-free communications device.

The firearm may include a sighting scope, wherein the (e) includes converting the machine-readable response into an audio response and image data, and (f) includes transmitting both the audio response and the image data to the hands-free communications device for simultaneous use of the audio response and the image data with the firearm sighting scope.

The machine-readable response may be stored in a memory, the memory being disposed remotely of hands-free communications device and the method may include (e) recalling the machine-readable response from the memory; (f) converting the machine-readable response to at least one of an audio response and image data; and (g) transmitting the at least one of the audio response and image data to the hands-free communications device for use by the operator in performing the sighting operation with the firearm.

The machine-readable response may be editable and the method may include (h) editing the machine-readable response prior to performing either one of (f) and (g)

The method may include (e) at least partially blocking noise generated as a result of shooting the firearm from being communicated to the hands-free communication device.

The method may include (e) transmitting the machine-readable response to the hands-free communication device in one of a first playback mode having a first playback length and a second playback mode having a second playback length, wherein the first playback length is longer than the second playback length.

It will be appreciated that various of the above-disclosed embodiments and other features and functions, or alternatives thereof, may be desirably combined into many other different systems or applications. Also, various presently unforeseen or unanticipated alternatives, modifications, variations or improvements therein may be subsequently made by those skilled in the art which are also intended to be encompassed by the following claims.

What is claimed is:

1. An apparatus for assisting an operator in aiming a firearm with a sighting scope, comprising:
a hands-free communications device including both an input device for generating an audio input and an output device for receiving a set of information, the set of information being usable by the operator for aiming the firearm;
a ballistics processing unit, said ballistics processing unit (i) receiving a machine-readable input and (ii) generating machine readable output, the machine readable output corresponding with the set of information usable by the operator for aiming the firearm with the sighting scope; and
an audio/visual interface, communicatively coupling said hands-free communication device and said ballistics processing unit, said audio interface (i) converting the audio based input generated with said hands-free communications device into the machine readable input, (ii) converting the machine readable output generated with said ballistics processing unit into the set of information usable by the operator for aiming the firearm with the sighting scope, and (iii) communicating the set of information usable by the operator for aiming the firearm with the sighting scope from said audio/visual interface to said hands-free communications device.

2. The apparatus of claim 1, wherein the set of information usable by the operator for aiming the firearm with the sighting scope is communicated to said hands-free communications device in an audio verbal format.

3. The apparatus of claim 2, wherein:
said hands-free communication device comprises a pair of wearable glasses with the pair of wearable glasses including a display portion,
the set of information usable by the operator for aiming the firearm with the sighting scope includes a set of image data, and
the image data is used to display at least part of the set of information for use by the operator in aiming the firearm with the sighting scope on the display portion.

4. The apparatus of claim 1, wherein the set of information usable by the operator for aiming the firearm with the sighting scope is communicated to said hands-free communications device in the form of one or more audible tones.

5. The apparatus of claim 1, wherein:
said hands-free communication device comprises a pair of wearable glasses with the pair of wearable glasses including a display portion,
the set of information usable by the operator for aiming the firearm with the sighting scope includes a set of image data, and
the image data is used to display at least part of the set of information for use by the operator in aiming the firearm with the sighting scope on the display portion.

6. The apparatus of claim 1, wherein said hands-free communication device is operatively associated with a low power wireless communication system.

7. The apparatus of claim 1, wherein said hands-free communication device is operatively associated with a noise filtering system, said noise filtering system at least partially blocking noise, generated as a result of shooting the firearm, from being transmitted to the operator.

8. The apparatus of claim 1, in which the sighting scope includes a graphic image pattern for aiming the firearm at an object, wherein the set of information usable by the operator for aiming the firearm comprises an audible firing solution with the audible firing solution being usable with the graphic image pattern to position the firearm with the sighting scope.

9. The apparatus of claim 1, further comprising a library including a plurality of formatted terms, wherein said ballistics processing unit uses the formatted terms to generate the set of information usable by the operator for aiming the firearm with the sighting scope.

10. The apparatus of claim 9, wherein at least part of the set of information usable by the operator for aiming the firearm with the sighting scope is created in response to matching a command communicated from the hands-free communication device with one of the formatted terms of the library.

11. The apparatus of claim 1, further comprising memory disposed remotely of the firearm, wherein the set of information usable by the operator for aiming the firearm with the sighting scope is stored in said memory disposed remotely of the firearm, and wherein the machine-readable input includes one or more instructions with the one or more instructions being used to develop at least part of the set of information usable by the operator for aiming the firearm with the sighting scope.

12. The apparatus of claim 11, in which the set of information usable by the operator for aiming the firearm with the sighting scope includes at least one of a parameter and data, wherein:
the set of information usable by the operator for aiming the firearm with the sighting scope is retrieved from said memory disposed remotely of the firearm, and
the at least one of the parameter and the data is edited in response to operator input.

13. The apparatus of claim 12, wherein the set of information usable by the operator for aiming the firearm with the sighting scope is stored in said memory disposed remotely of the firearm subsequent to editing the at least one of the parameter and the data.

14. The apparatus of claim 11, in which a plurality of information sets usable by the operator for aiming the firearm are stored in said memory disposed remotely of the firearm, wherein an instruction, in addition to the one or more instructions, is used to retrieve one of the plurality of information sets for use by the operator in aiming the firearm.

15. The apparatus of claim 1, wherein the set of information usable by the operator for aiming the firearm is communicated to the operator in one of at least two selectable audible playback modes.

16. The apparatus of claim 15, in which the at least two selectable audible playback modes correspond respectively with a first playback length and a second playback length, wherein the first playback length is longer than the second playback length.

17. The apparatus of claim 1, in which a set of windage related information is communicated to said ballistics processing unit, wherein said ballistics processing unit generates windage compensation feedback, and wherein the set of information usable by the operator for aiming the firearm with the sighting scope includes the windage compensation feedback.

18. A method for assisting a sighting operation by an operator with a firearm, comprising:
(a) receiving, at an audio recognition device, an audio based command from a hands-free communications device;
(b) using the audio recognition device to convert the audio based command into a machine-readable command, wherein the machine-readable command is associated with at least one parameter;
(c) using a ballistics processing device to (i) search a library of pre-formatted commands to determine if a match exists between the machine-readable command and one of the pre-formatted commands, and (ii) determine whether a selected relationship, warranting execution of the machine readable command by the ballistics processing device, exists between the at least one parameter and the machine readable command; and
(d) responsive to finding a match between the machine-readable command and one of the pre-formatted commands as well as determining that the selected relationship exists between the at least one parameter and the machine-readable command, executing the machine readable command to generate a machine readable response.

19. The method of claim 18, further comprising:
(e) converting the machine-readable response to at least one of an audio response and image data; and
(f) transmitting the at least one of the audio response and image data to the hands-free communications device for use by the operator in performing the sighting operation with the firearm.

20. The method of claim 19, wherein said (e) includes converting the machine-readable response to an audio response, and (f) includes transmitting the audio response to the hands-free communication device.
